(19) United States
(12) Patent Application Publication
(10) Pub. No.: US 2019/0180335 A1
(43) Pub. Date: Jun. 13, 2019

(54) NETWORK INFRASTRUCTURE OPTIMIZATION PLATFORM

(71) Applicant: Accenture Global Solutions Limited, Dublin (IE)

(72) Inventors: Bora Goekbora, Brooklyn, NY (US); Scott Saiget, New York, NY (US); Natalie H. Mckeever, Atlanta, GA (US); Syed Feroze H. Shah, Cambridge, MA (US); Terry Wayne Steger, Dallas, TX (US); Sumit Banerjee, Mclean, VA (US); Sean Delaney, Hoboken, NJ (US)

(21) Appl. No.: 15/835,767

(22) Filed: Dec. 8, 2017

(51) Int. Cl. G06Q 30/02; G06Q 10/06; H04L 12/24

(52) U.S. Cl. CPC G06Q 30/0283; H04L 41/145; G06Q 30/0201; G06Q 10/0637

(57) ABSTRACT

Implementations are directed to receiving, by a NIO platform, one or more sets of data, the one or more sets of data including a set of historical data, and a set of opportunity data, processing, by the NIO platform, at least the set of historical data to determine a sub-set of data, the sub-set of data including data types having a relatively high impact on network infrastructure cost, providing, by the NIO platform, respective cost estimations for two or more network infrastructure opportunities by processing the set of opportunity data using a cost model provided from the sub-set of data, prioritizing, by the NIO platform, two or more network infrastructure opportunities relative to each other, and transmitting, by the NIO platform, one or more visualizations for display to a user on a computing device, the one or more visualizations graphically depicting prioritization of the two or more network infrastructure opportunities.

### BACKGROUND

Network infrastructure for communication networks (e.g., cellular networks) is a significant resource investment for enterprises. A network infrastructure includes physical components (assets), such as cellular towers, which relay communications between network end-points (e.g., cellular telephones). Planning of the network infrastructure involves determining geographic locations for assets. The location of assets can significantly affect the reach (in terms of number of users), reliability, and efficiency of the communications network. Consequently, planning of the network infrastructure seeks to optimize the location of assets. However, planning network infrastructure is time, and resource intensive, and can be inefficient, imprecise, and prone to errors in that less relevant factors may be considered in the planning process.

### SUMMARY

Implementations of the present disclosure are generally directed to network infrastructure optimization. More particularly, implementations of the present disclosure are directed to a network infrastructure optimization (NIO) platform for optimizing network infrastructure planning for communications organizations.

In some implementations, actions include receiving, by a NIO platform executed by one or more processors, one or more sets of data, the one or more sets of data including a set of historical data, and a set of opportunity data, processing, by the NIO platform, at least the set of historical data to determine a sub-set of data, the sub-set of data including data types having a relatively high impact on network infrastructure cost, providing, by the NIO platform, respective cost estimations for two or more network infrastructure opportunities by processing the set of opportunity data using a cost model provided from the sub-set of data, prioritizing, by the NIO platform, two or more network infrastructure opportunities relative to each other, and transmitting, by the NIO platform, one or more visualizations for display to a user on a computing device, the one or more visualizations graphically depicting prioritization of the two or more network infrastructure opportunities. Other implementations of this aspect include corresponding systems, apparatus, and computer programs, configured to perform the actions of the methods, encoded on computer storage devices.

These and other implementations can each optionally include one or more of the following features: prioritizing includes providing a zoning tier and an executabiltiy tier to each network infrastructure opportunity of the two or more network infrastructure opportunities; the set of data includes data types including infrastructure data, and census block data; the infrastructure data includes two or more of annual cost, location, asset type, asset owner, owner size, tenure, and date of lease expiration; the census block data, for a given location, includes one or more of total population, population density, housing unit density, number of businesses, house price index, per capita income, size of census block, number of alternative infrastructure in each census block, and zoning; the sub-set of data includes data types including asset type, owner, and census block population density; and at least one network infrastructure opportunity includes a multi-carrier opportunity based on a geographical overlap.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is an example architecture within which implementations of the present disclosure can be executed.

FIG. 2 is a block diagram of an example module architecture for a network infrastructure optimization (NIO) platform in accordance with implementations of the present disclosure.

FIGS. 3A and 3B are example output visualizations in accordance with implementations of the present disclosure.

FIG. 4 is an example process that can be executed in accordance with implementations of the present disclosure.

### DETAILED DESCRIPTION

Implementations of the present disclosure are generally directed to network infrastructure optimization. More particularly, implementations of the present disclosure are directed to a network infrastructure optimization (NIO) platform for optimizing network infrastructure planning for communications organizations. In some implementations, actions include receiving, by a NIO platform executed by one or more processors, one or more sets of data, the one or more sets of data including a set of historical data, and a set of opportunity data, processing, by the NIO platform, at least the set of historical data to determine a sub-set of data, the sub-set of data including data types having a relatively high impact on network infrastructure cost, providing, by the NIO platform, respective cost estimations for two or more network infrastructure opportunities by processing the set of opportunity data using a cost model provided from the sub-set of data, prioritizing, by the NIO platform, two or more network infrastructure opportunities relative to each other, and transmitting, by the NIO platform, one or more visualizations for display to a user on a computing device, the one or more visualizations graphically depicting prioritization of the two or more network infrastructure opportunities.

As introduced above, network infrastructure for communication networks (e.g., cellular networks) is a significant resource investment for enterprises. A network infrastructure includes physical components (assets), such as cellular towers, which relay communications between network end-points (e.g., cellular telephones). Planning of the network infrastructure involves determining geographic locations for assets. The location of assets can significantly affect the reach (in terms of number of users), reliability, and efficiency of the communications network. Consequently, planning of the network infrastructure seeks to optimize the location of assets. However, planning network infrastructure is time, and resource intensive, and can be inefficient and imprecise in that less relevant factors may be considered in the planning process.

In view of the foregoing, and as described in further detail herein, implementations of the present disclosure provide a network infrastructure optimization (NIO) platform for optimizing network infrastructure planning for communications organizations (e.g., enterprises providing cellular network infrastructure, and/or services; also referred to herein as carriers). Additionally, implementations of the present disclosure identify areas where factors (e.g., zoning) may conflict with portfolio-wide infrastructure (e.g., national or cross-regional), and real-estate planning (e.g., leasing/purchasing real estate to locate assets).

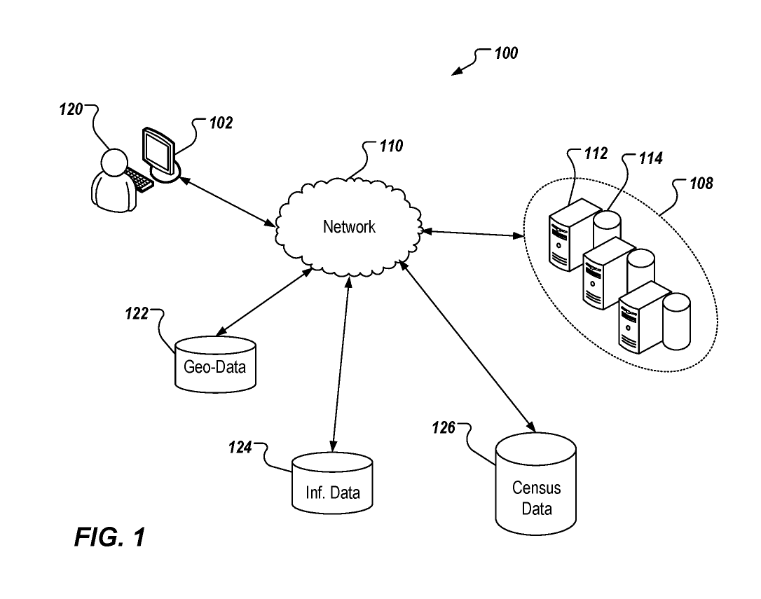

FIG. 1 is an example architecture 100 within which implementations of the present disclosure can be executed. The example architecture 100 includes a computing device 102, a back-end system 108, and a network 110. In some examples, the network 110 includes a local area network (LAN), wide area network (WAN), the Internet, or a combination thereof, and connects web sites, devices (e.g., the computing device 102), and back-end systems (e.g., the back-end system 108). In some examples, the network 110 can be accessed over a wired and/or a wireless communications link. For example, mobile computing devices, such as smartphones can utilize a cellular network to access the network 110.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host the NIO platform in accordance with implementations of the present disclosure.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

The example system 100 also includes a plurality of data sources 120. In accordance with implementations of the present disclosure, example data sources include, without limitation, a geographical data source 122, an infrastructure data source 124, and a census data source 126. In some examples, one or more data sources can be provided from a single provider (e.g., a government agency). In some examples, one or more data sources can be provided from multiple providers (e.g., a government agency, one or more carriers, private sources).

In accordance with implementations of the present disclosure, the NIO platform is an automated, model-based platform for aggregating data from multiple, disparate data sources (e.g., geographic data, infrastructure data, census data, commercial data, user data, financial data, legal data, carrier data), and processing the data to identify opportunities for cost savings, and optimal areas for network expansion. In some implementations, the NIO platform uses regression analysis to identify inputs that have a high correlation to network infrastructure spend. For example, a set of data (e.g., including approximately 30 data types (inputs)), including data from multiple data sources, can be aggregated into a single database. Linear regression is performed to identify a sub-set of data, which includes inputs that have a relatively high correlation to impact on infrastructure spend.

In some implementations, the set of data provided as input for linear regression includes, without limitation, infrastructure data, and census block data. In some examples, the infrastructure data includes annual cost, location (e.g., latitude, longitude), asset type (e.g., stealth tower, water tank, rooftop, macro site, small cells, distributed antenna system (DAS), fiber optic cabling), asset owner (e.g., publicenterprise, private enterprise), owner size (e.g., based on financial data), tenure, and date of existing lease expiration. Example census block data, for a given location, includes total population, population density, housing unit density, number of businesses, house price index, per capita income, size of census block, number of alternative infrastructure in each census block, as well as zoning (e.g., residential, non-residential, commercial, mixed use).

In some implementations, the linear regression provides a statistical analysis across a combination of types of data in the set of data. Based on the statistical analysis, the following example inputs (sub-set of data of the set of data) are determined to be the most impactful on infrastructure cost: asset type, owner type, census block population density. Consequently, a data model is provided, which includes the sub-set of data as predictive attributes.

In some implementations, the NIO platform estimates projected cost of existing, and/or proposed infrastructure in a time-sensitive and inexpensive manner. In some examples, a sub-set of data (e.g., data values for a target location) is processed using the data model to estimate the projected spend of an individual infrastructure asset, or network of assets. In some implementations, one or more infrastructure portfolios (e.g., an asset portfolio of each carrier) is processed using the cost model. In some examples, current infrastructure costs are compared to predicted “should-cost” values that are determined using the cost model (e.g., processing census block, and infrastructure data). In some examples, a should-cost indicates an expected (predicted) cost associated with an asset. In this manner, deltas can be determined in bulk to provide time-efficiency, and additional analysis is performed to identify opportunities to minimize variance between actual costs and “should-cost” values.

In some implementations, the NIO platform identifies opportune areas for future network buildouts based on geospatial zoning analysis. In some implementations, the NIO platform quantifies an overall cost savings opportunity for network infrastructure spend. In a single-carrier approach, a single carrier's cost and location data can be compared to the predictive “should cost” outputs from the cost model to assess excessive, or unjustified, high expense areas (deltas) for additional analysis. In some examples, this can be performed for existing infrastructure, and/or future (to-be-built) infrastructure. In a multi-carrier approach, infrastructure from multiple, different carriers can be compared by location in order to determine mutual overlap areas, or pairs, between the multiple carriers. In some implementations, two or more overlap areas can be ranked and categorized for new infrastructure builds in order to minimize expense. For example, existing high cost infrastructure can be switched to the lowest expense area for a new infrastructure build determined using the NIO platform of the present disclosure, which also identifies specific areas where infrastructure would have a high likelihood of being built.

In further detail, asset relocation, and/or infrastructure expansion opportunities are prioritized based on probability of reducing, and/or limiting infrastructure spend. Example factors influencing the ranking include, without limitation, total cost savings, population density, ownership structure, infrastructure type, and zoning feasibility. In some examples, respective priority scores are determined by weighting the projected cost savings for each opportunity by the number of available asset relocation opportunities, the remaining time on current contract terms, if any, (assuming assets are leased), the aggregate asset spend (e.g., with a lessor), and a difference in spend between the asset and other assets within a specified geographic radius (to compare assets that cover comparable network service areas). In some implementations, a priority score is determined based on the following example input, and order of weighting: number of alternative sites, market price of alternative sites, amount of spend with infrastructure providers, termination date of existing leases, and delta between current costs and predicted costs. In some examples, the example inputs are weighted by variable, with certain variables being weighted from 5%-60%, and an aggregate priority score is provided.

Implementations of the present disclosure are described in further detail herein with reference to an example context. The example context includes opportunities for locating an asset (e.g., a cellular tower) to be used by multiple service providers (e.g., carriers). It is contemplated, however, that implementations of the present disclosure can be realized in any appropriate context (e.g., a single service provider).

In accordance with implementations of the present disclosure, the NIO platform identifies potential build-to-suit locations using geographic match analysis, and site data provided by the carriers. In some examples, search ring radii are used, and are approved by the respective carriers based on carrier-specific parameters and tolerances. In some examples, any matched areas (e.g., defined as overlap in search rings) are analyzed to determine a zoning feasibility score using proxy data sources (e.g., census data, zoning data), as described in further detail herein. In some examples, the zoning proxy score represents a likelihood that a respective zone is highly probable for new infrastructure, and the priority score represents relative potential for cost reduction based on the predictive market analysis provided by the NIO platform. An executability assessment is provided, and includes zoning feasibility, and site proximity data for each matched location.

With regard to geographic matching, geographic locations (sites) from each carrier are mapped (e.g., using a computer-implemented mapping service), and search rings are used to identify overlap areas between sites. That is, the search rings are used to identify geographic matches between the carriers (e.g., Carrier 1, Carrier 2). In some examples, each of the search ring sizes (e.g., radii) are provided, and/or approved by the carriers. Example search rings can be provided based on a classification of the geographic location, as depicted in the example table below:

TABLE 1
Example Search Ring Sizes

| | | Carrier Defined |
|---|---|---|
| Type | Census Block Criteria | Search Ring (mi) |
| Rural | Outside Urban Area/ | 2.5 |
| | <500 Housing Unit | |
| | Density | |
| Suburban | Inside UA/500-5,000 | 1.0 |
| | Housing Unit Density | |
| Urban | Inside UA/5,000-50,000+ | 0.50 |
| | Housing Unit | |
| | Density | |

In some implementations, the NIO platform evaluates zoning feasibility for each geographic match by considering local zoning, and demographic data in conjunction with supplementary data (e.g., federal government data). In further detail, the NIO platform processes local zoning data, third party zoning data, and census demographic data using a rules engine in a primary analysis to determine zoning feasibility tiers for each match. In addition to the primary analysis, the NIO platform performs a secondary analysis based on the supplemental data (e.g., NEPA registration requirements, and federally protected zones) in assigning tiers. In some implementations, matches are categorized as urban/high density suburban, or low density suburban/rural. Example zoning feasibility tiers include:
Z1—Likely to have high overlap with non-residential zoning areas or is a non-urban area of extremely low housing density (rural).
Z2—Likely to have moderate overlap with non-residential zoning areas, may be either urban/high density suburban or low density suburban/rural.
Z3—Likely to have minimal overlap with non-residential zoning areas, may be either urban/high density suburban or low density suburban/rural.
Z4—Highly likely to be residentially zoned, may be either urban/high density suburban or low density suburban/rural.

In some implementations, one or more visualizations are provided to graphically depict data underlying the feasibility. In some examples, the one or more visualizations each include a map of a geographic location (e.g., including potential infrastructure sites), and can have one or more layers. Example layers can include visualizations of underlying census block data, and highlight robustness and variance amongst census blocks along with the emphasis that these data sets are not flat and have spatial context (e.g., shapes, geographies, intersections). In some examples, spatial characteristics of the analysis provided by the NIO platform cannot be completed with tabular data. For example, there are components of the analysis that require spatial characteristics (e.g., distance, area, geographic location, search rings) that are not effectively presented with just spreadsheets/tabular data. Consequently, the one or more visualizations plot the census block information to enable users to visualize the data.

The executability assessment is provided based on the above-described outputs. In the executability assessment, match locations are categorized into executability tiers using site proximity, and zoning feasibility for each match. In some implementations, the NIO platform executes a combined analysis of matched carrier locations across the proximity between the matched sites, and the respective zoning feasibilities. The resulting output includes an executability tier for each location match, the executability tier indicating the likelihood (for each match) of successfully identifying a new, joint (e.g., in multi-carrier scenarios) build-to-suit location for an asset (e.g., cellular tower). Example executability tiers include:
Tier 1—Optimal: Tier 1 matches demonstrate a high likelihood of successfully relocating to a joint build-to-suit location. The matches in this tier have close site proximity and favorable zoning environments.
Tier 2—Possible: Tier 2 matches demonstrate a moderate likelihood of successfully relocating to a joint build-to-suit location. These matches are likely to have medium proximity sites and a medium degree of zoning feasibility.
Tier 3—Challenging: Tier 3 matches demonstrate a minimal likelihood of successfully relocating to a joint build-to-suit location. These matches are likely to have challenging site proximity and/or challenging zoning feasibility.
Tier 4—Unlikely: Tier 4 matches are unlikely to yield suitable joint build-to-suit locations and are not worth pursuing outside of truly exceptional circumstances.

In accordance with implementations of the present disclosure, the NIO platform provides linear regression, and model-based analysis in conjunction with a feasibility analysis. For example, and as described in further detail herein, portfolio infrastructure data is provided from a carrier (or multiple carriers), the portfolio is analyzed by the NIO platform to determine which sites/infrastructure have a higher cost than wanted, and targeted cost reduction for existing infrastructure is provided by the NIO platform in order to reduce cost. Further, the NIO platform can evaluate opportunities to quickly and efficiently build alternative infrastructure.

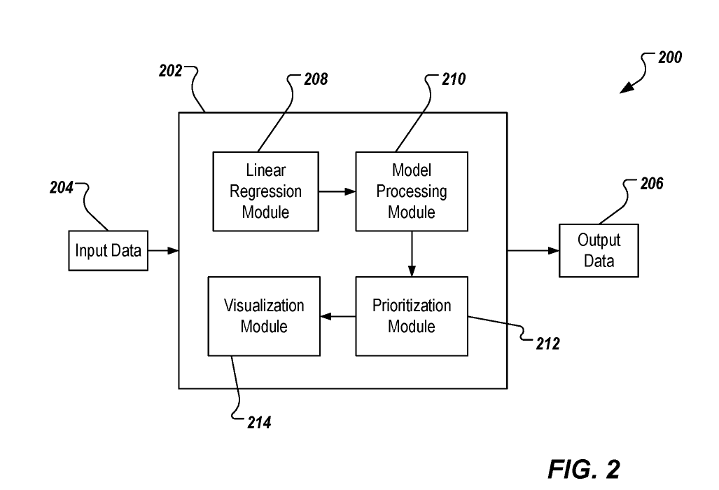

FIG. 2 is a block diagram of an example module architecture 200 for the NIO platform in accordance with implementations of the present disclosure. In the depicted example, the example module architecture 200 includes a NIO platform 202 that processes input data 204 to provide output data 206. The NIO platform 202 includes a linear regression module 208, a model processing module 210, a prioritization module 212, and a visualization module 214. In some examples, the input data 204 includes historical data associated with one or more network assets of one or more carriers. In accordance with implementations of the present disclosure, the linear regression module 208 processes at least a portion of the input data to determine data types having a relatively high impact on infrastructure cost. For example, and as described above, linear regression of historical data can reveal a sub-set of data including asset type, owner, and census block population density as the most impactful parameters.

In some implementations, the model processing module 210 processes at least a portion of the input data 204 to provide respective asset costs for infrastructure opportunities. More particularly, the model processing module 210 processes at least a portion of the input data 204 using the cost-based model provided from the sub-set of data. For example, the input data 204 can include current, and/or prospective data associated with an asset (e.g., asset type, owner (carrier), and/or location (e.g., block population density), and the model can provide respective cost estimations for each opportunity. In some examples, at least a portion of the output data 206 includes the respective cost estimations. In some implementations, the prioritization module 212 prioritizes two or more infrastructure opportunities, as described herein. For example, the prioritization module 212 can assign a zoning feasibility tier, and/or an executability tier to each infrastructure opportunity. In some implementations, the visualization module 214 provides one or more visualizations that can be displayed to users. In some examples, at least a portion of the output data 206 includes the one or more visualizations. Example visualizations are describe below.

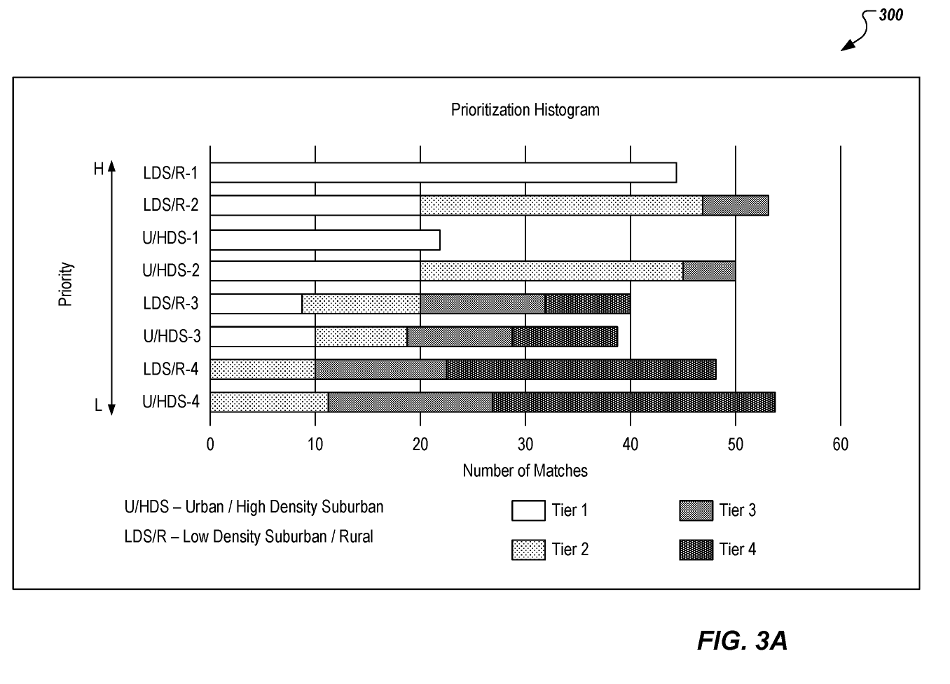

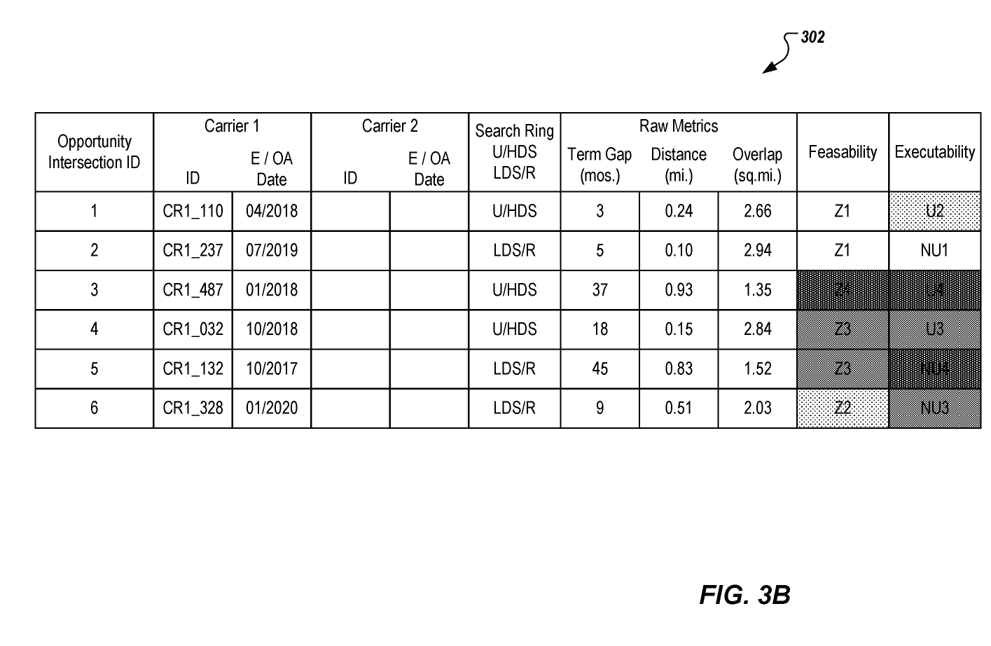

FIGS. 3A and 3B are example output visualizations 300, 302, respectively, in accordance with implementations of the present disclosure. In the example of FIG. 3A, the visualization 300 is provided as a prioritization histogram. More particularly, the prioritization histogram provides a number of matches based on executability tiers, and ranked by priority. In the example of FIG. 3B, the visualization 302 is provided as a table of matched sites between multiple carriers, and providing corresponding match data (e.g., proximity, term gap, overlap area, tiered feasibility, tiered executability for respective overlap areas (matched sites)). In the example of FIG. 3B, the visualization 302 is provided for a first carrier (Carrier 1). Consequently, confidential information may be absent from the visualization 302 (e.g., details of a second carrier (Carrier 2)).

The example visualizations 300, 302 of FIGS. 3A and 3B, respectively, are not exclusive of visualizations that can be provided by the NIO platform of the present disclosure. Other example visualizations can include, without limitation, an aggregate term gap histogram, an aggregate proximity histogram, executability distributions, proximity histograms by tier, and match distributions. In some examples, a term gap can be described as a gap, or difference, between one carrier's existing lease, and another carrier's existing lease in a multi-carrier scenario.

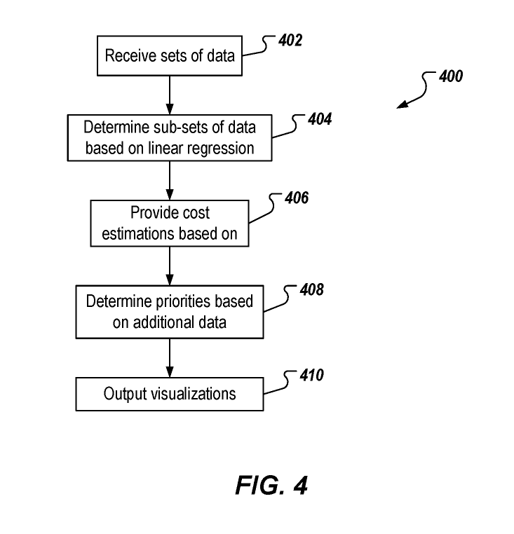

FIG. 4 depicts an example process 400 that can be executed in accordance with implementations of the present disclosure. In some implementations, the example process 400 is provided using one or more computer-executable programs executed by one or more computing devices (e.g., the back-end system 108 of FIG. 1, the example NIO platform 202 of FIG. 2).

One or more sets of data are received (402). For example, the NIO platform 202 of FIG. 2 receives the input data 204, which includes one or more sets of data. An example set of data includes historical data for one or more assets, and locations. One or more sub-sets of data are determined based on linear regression (404). For example, the linear regression module 208 processes at least a portion of the input data 204 (e.g., historical data) to determine a sub-set of data including data types having a relatively high impact on infrastructure cost. For example, and as described above, linear regression of historical data can reveal a sub-set of data including asset type, owner, and census block population density as the most impactful parameters.

Costs estimations are provided for respective infrastructure opportunities (406). For example, the model processing module 210 processes at least a portion of the input data 204 using the cost-based model provided from the sub-set of data. The input data 204 can include current, and/or prospective data associated with an asset (e.g., asset type, owner (carrier), and/or location (e.g., block population density), and the model can provide respective cost estimations for each opportunity. One or more priorities are determined based on additional data (408). For example, the prioritization module 212 prioritizes two or more infrastructure opportunities, as described herein. For example, the prioritization module 212 can assign a zoning feasibility tier, and/or an executability tier to each infrastructure opportunity. One or more visualizations are output (410). For example, the visualization module 214 provides one or more visualizations as at least a portion of the output data 206. Example visualizations are depicted in FIGS. 3A and 3B, as described herein.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for network infrastructure optimization (NIO), the method being executed by one or more processors and comprising:
receiving, by a NIO platform executed by the one or more processors:
one or more sets of data,
the one or more sets of data comprising a set of historical data, and a set of opportunity data;
processing, by the NIO platform, at least the set of historical data to determine a sub-set of data,
the sub-set of data comprising data types having a relatively high impact on network infrastructure cost;
providing, by the NIO platform, respective cost estimations for two or more network infrastructure opportunities,
the providing performed by processing the set of opportunity data using a cost model provided from the sub-set of data;
prioritizing, by the NIO platform, two or more network infrastructure opportunities relative to each other; and
transmitting, by the NIO platform, one or more visualizations for display to a user on a computing device,
the one or more visualizations graphically depicting prioritization of the two or more network infrastructure opportunities.

2. The method of claim 1, wherein prioritizing comprises providing a zoning tier and an executabiltiy tier to each network infrastructure opportunity of the two or more network infrastructure opportunities.

3. The method of claim 1, wherein the set of data comprises data types comprising infrastructure data, and census block data.

4. The method of claim 3, wherein the infrastructure data comprises two or more of annual cost, location, asset type, asset owner, owner size, tenure, and date of lease expiration.

5. The method of claim 3, wherein the census block data, for a given location, comprises one or more of total population, population density, housing unit density, number of businesses, house price index, per capita income, size of census block, number of alternative infrastructure in each census block, and zoning.

6. The method of claim 1, wherein the sub-set of data comprises data types comprising asset type, owner, and census block population density.

7. The method of claim 1, wherein at least one network infrastructure opportunity comprises a multi-carrier opportunity based on a geographical overlap.

8. One or more non-transitory computer-readable storage media coupled to one or more processors and having instructions stored thereon which, when executed by the one or more processors, cause the one or more processors to perform operations for network infrastructure optimization (NIO), the operations comprising:
receiving, by a NIO platform executed by the one or more processors:
one or more sets of data,
the one or more sets of data comprising a set of historical data, and a set of opportunity data;
processing, by the NIO platform, at least the set of historical data to determine a sub-set of data,
the sub-set of data comprising data types having a relatively high impact on network infrastructure cost;
providing, by the NIO platform, respective cost estimations for two or more network infrastructure opportunities,
the providing performed by processing the set of opportunity data using a cost model provided from the sub-set of data;
prioritizing, by the NIO platform, two or more network infrastructure opportunities relative to each other; and
transmitting, by the NIO platform, one or more visualizations for display to a user on a computing device,
the one or more visualizations graphically depicting prioritization of the two or more network infrastructure opportunities.

9. The computer-readable storage media of claim 8, wherein prioritizing comprises providing a zoning tier and an executabiltiy tier to each network infrastructure opportunity of the two or more network infrastructure opportunities.

10. The computer-readable storage media of claim 8, wherein the set of data comprises data types comprising infrastructure data, and census block data.

11. The computer-readable storage media of claim 10, wherein the infrastructure data comprises two or more of annual cost, location, asset type, asset owner, owner size, tenure, and date of lease expiration.

12. The computer-readable storage media of claim 10, wherein the census block data, for a given location, comprises one or more of total population, population density, housing unit density, number of businesses, house price index, per capita income, size of census block, number of alternative infrastructure in each census block, and zoning.

13. The computer-readable storage media of claim 8, wherein the sub-set of data comprises data types comprising asset type, owner, and census block population density.

14. The computer-readable storage media of claim 8, wherein at least one network infrastructure opportunity comprises a multi-carrier opportunity based on a geographical overlap.

15. A system, comprising:
one or more processors; and
a computer-readable storage device coupled to the one or more processors and having instructions stored thereon which, when executed by the one or more processors, cause the one or more processors to perform operations for network infrastructure optimization (NIO), the operations comprising:
receiving, by a NIO platform executed by the one or more processors:
one or more sets of data,
the one or more sets of data comprising a set of historical data, and a set of opportunity data;
processing, by the NIO platform, at least the set of historical data to determine a sub-set of data,
the sub-set of data comprising data types having a relatively high impact on network infrastructure cost;
providing, by the NIO platform, respective cost estimations for two or more network infrastructure opportunities,
the providing performed by processing the set of opportunity data using a cost model provided from the sub-set of data;
prioritizing, by the NIO platform, two or more network infrastructure opportunities relative to each other; and
transmitting, by the NIO platform, one or more visualizations for display to a user on a computing device,
the one or more visualizations graphically depicting prioritization of the two or more network infrastructure opportunities.

16. The system of claim 15, wherein prioritizing comprises providing a zoning tier and an executabiltiy tier to each network infrastructure opportunity of the two or more network infrastructure opportunities.

17. The system of claim 15, wherein the set of data comprises data types comprising infrastructure data, and census block data.

18. The system of claim 17, wherein the infrastructure data comprises two or more of annual cost, location, asset type, asset owner, owner size, tenure, and date of lease expiration.

19. The system of claim 17, wherein the census block data, for a given location, comprises one or more of total population, population density, housing unit density, number of businesses, house price index, per capita income, size of census block, number of alternative infrastructure in each census block, and zoning.

20. The system of claim 15, wherein the sub-set of data comprises data types comprising asset type, owner, and census block population density.
